(19) United States
(12) Patent Application Publication
(10) Pub. No.: US 2005/0225678 A1
(43) Pub. Date: Oct. 13, 2005

(54) Object retrieval

(76) Inventors: Andrew Zisserman, Oxford (GB); Frederik Schaffalitzky, Oxford (GB); Josef Sivic, Oxford (GB)

Correspondence Address: Richard S. Myers, Jr.;Stites & Harbison PLLC, Suite 1800, 424 Church Street, Nashville, TN, 37219-2376, US

(21) Appl. No.: 10/820,671

(22) Filed: Apr. 8, 2004

(51) Int. Cl. G06K 9/00; H04N 5/14; H04N 9/64

(52) U.S. Cl. 348/571

(57) ABSTRACT

A method of identifying a user-specified object contained in one or more images of a plurality of images that comprises the steps of defining regions of objects in the images, and computing a vector in respect of each of the regions based on the appearance of the respective region. The vector comprises a descriptor. The method further comprises vector quantizing the descriptors into clusters, storing the clusters as an index with the images in which they occur, defining regions of the user-specified object, computing a vector in respect of each of said regions based on the appearance of the regions, and vector quantizing the descriptors into one or more clusters. The index is searched and the clusters are compared with the contents of the index to identify which of the images contain the clusters so as to return the images containing the user-defined object.

This invention relates to a system and method for object retrieval and, more particularly, to a system and method for object matching and retrieval within an image or series of images.

This invention builds a visual analogy to a text retrieval system. In typical text retrieval systems, a number of standard steps known to a person skilled in the art are generally employed. The documents are first parsed into words. Next, the words are represented by their ‘stems’, for example, ‘walk’, ‘walks’ and ‘walking’ would be represented by the stem ‘walk’. Third, a stop list is used to reject very common words, such as ‘the’ and ‘an’, which occur in most documents and are therefore not discriminating for a particular document. The remaining words are then assigned a unique identifier, and each document is represented by a vector with components given by the frequency of occurrence of the words the document contains. In addition, the components are weighted in various ways. In one known arrangement comprising an internet search engine, the weighting of a web page depends on the number of web pages linking to that particular web page. All of the above steps are carried out in advance of actual retrieval, and the set of vectors representing all of the documents in a corpus are organised as an ‘inverted file’ to facilitate efficient retrieval. An inverted file is structured like an ideal book index. It has an entry for each word in the corpus, followed by a list of all the documents (and position in that document) in which the word occurs. A text is retrieved by computing its vector of word frequencies and returning the documents with the closest (measured by angles) vectors. In addition, the match on the ordering and separation of the words may be used to rank the returned documents in order of their perceived relevance relative to the user-defined text used to initiate the search.

However, in the field of object retrieval, no such efficient and convenient approach has been employed, and no analogous method of ranking ‘hits’ in order of their relevance to a user's enquiry is currently provided.

Object retrieval is one of the crucial tasks in computer vision and, in particular, the process of finding instances of three-dimensional objects using one or more two-dimensional images of a scene. It is a challenging problem because an object's visual appearance may be very different due to the viewpoint and lighting, and it may be partially occluded, but some successful methods do now exist. Typically, in such methods, an image of an object is represented by a set of overlapping regions, each represented by a vector computed from the region's appearance. The region segmentation and descriptors are built with a controlled degree of invariance to viewpoint and illumination conditions. Similar descriptors are computed for all images in a database. Recognition of a particular object proceeds by nearest neighbour matching of the descriptor vectors, followed by disambiguating using local spatial coherence (such as neighbourhoods, ordering or spatial layout), or global relationships (such as epipolar geometry). Other methods have been proposed whereby object matching and retrieval has been achieved based on colour and/or texture histograms, for example.

However, known methods for object retrieval possess several shortcomings, including the fact that none of the approaches are sufficiently robust against occlusion, clutter, viewpoint changes and image intensity changes, and also that they tend not to be efficient enough if a search for an object is required to be carried out in respect of large numbers of individual images.

We have now devised an improved arrangement.

In accordance with a first aspect of the present invention, there is provided a method of identifying a user-specified object contained in one or more images of a plurality of images, the method comprising defining regions of objects in said images, computing a vector in respect of each of said regions based on the appearance of the respective region, each said vector comprising a descriptor, vector quantizing said descriptors into clusters, storing said clusters as an index with the images in which they occur, defining regions of said user-specified object, computing a vector in respect of each of said regions based on the appearance of said regions, each said vector comprising a descriptor, and vector quantizing said descriptors into one or more clusters, searching said index and comparing said one or more clusters with the contents of said index and identifying which of said plurality of images contains said clusters so as to return the images containing said user- defined object.

In one embodiment, the method may further comprise comparing the clusters relating to the objects contained in the images identified as containing an occurrence of said user- specified object with the one or more clusters relating to said user-specified object, and ranking said images identified as containing an occurrence of said user-specified object according to the similarity of the clusters associated therewith to the one or more clusters associated with said user-specified object.

In a preferred embodiment, at least two types of viewpoint covariant regions are defined in respect of each of said images. More preferably, a descriptor is computed in respect of each type of viewpoint covariant region, and separate clusters are beneficially formed in respect of each type of viewpoint covariant region accordingly. The at least two types of viewpoint covariant regions may include Shape Adapted and Maximally Stable regions respectively.

In accordance with a second aspect of the present invention, there is provided a method of identifying a user-specified object contained in one or more image frames of the moving picture, the method comprising associating a plurality of different ‘visual aspects’ with each of a plurality of respective objects in said moving picture, retrieving the ‘visual aspects’ associated with said user-specified object and matching said ‘visual aspects’ associated with said user-specified object with objects in said frames of said moving picture so as to identify instances of said user-specified object in said frames.

The ‘visual aspects’ associated with an object are preferably obtained using one or more moving sequences or shots of the moving picture in which the object occurs. This may be achieved by tracking the object through a plurality of frames in a sequence. In one embodiment, the method comprises defining affine invariant regions of objects in the image frames and tracking one or more regions through a plurality of image frames in a sequence.

Beneficially, if a track terminates in an image frame of the sequence, the method further comprises propagating the track to either following or preceding image frames in the sequence, so as to create a substantially continuous track between respective regions in the sequence.

Thus, the second aspect of the present invention provides a method for automatically associating image regions from frames of a shot into object-level groups. The grouping method employs both the appearance and motion of the patches. By associating ‘visual aspects’, for example, front, back and side views, with an object, the object retrieval method becomes substantially orientation invariant such that all instances of a user- specified object can be retrieved, irrespective of the orientation of the object in the scene.

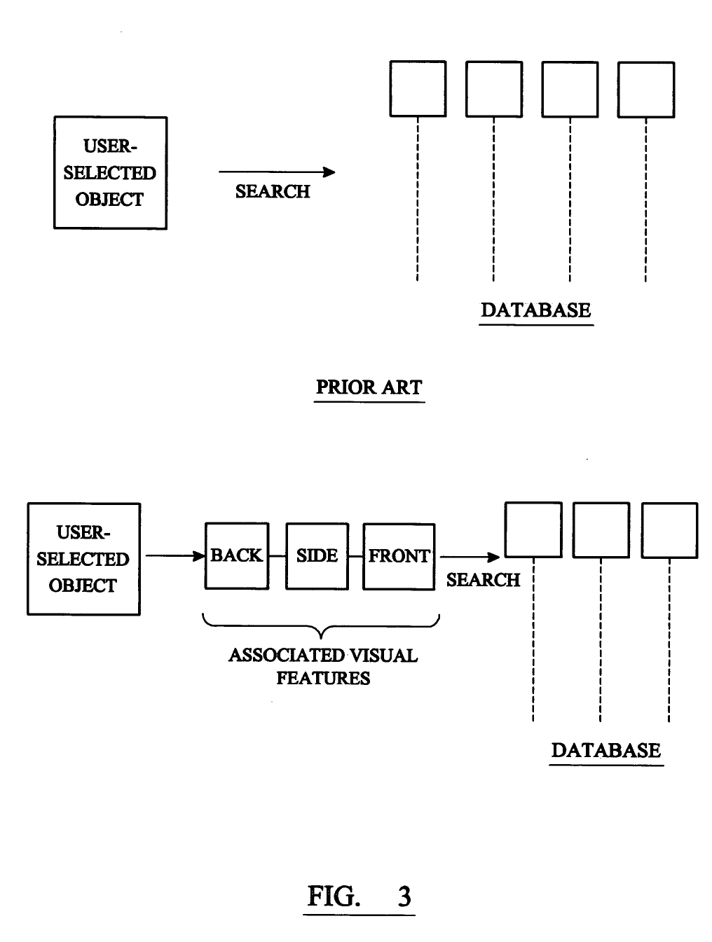

The principle of the method according to the second aspect of the invention can be seen more clearly with reference to FIG. 3 of the drawings. Thus, referring to the top diagram, in prior art object retrieval methods, a user selects an object for retrieval by specifying a portion of an image containing that object. A search is then carried out through a database of images for occurrences of the user-selected object. However, the only images which will be returned are those containing the object from the similar viewpoint as that in the user selected portion of the image. In a method according to the second aspect of the present invention, on the other hand, several ‘visual aspects’, for example, back, front and side views, are associated with each object, such that when the user selects an object for retrieval, the ‘visual aspects’ associated therewith are first retrieved, and then a search is carried out through the database of images for occurrences of all of the associated ‘visual aspects’, so as to ensure that substantially all of the images containing occurrences of the user-selected object are returned (see bottom diagram of FIG. 3). Such association of ‘visual aspects’ with an object is possible, in accordance with a preferred embodiment of the present invention, because those ‘visual aspects’ appears in one shot in which it was possible to group the aspects by the motion in the shot.

One preferred feature of this aspect lies in the use of affine invariant regions to group the object across frames. There are at least two significant benefits; first, the affine invariant regions are used to repair short gaps in individual tracks, and also to join sets of tracks across occlusions (where many tracks are lost simultaneously); second, a robust affine factorization method may be developed which is able to cope with motion degeneracy. This factorization can be used to associate tracks into object-level groups.

The outcome is that separate parts of an object that are never visible simultaneously in a single frame may be grouped together. For example, the front and back of a car, or one side of a building with another. In turn this enables object-level matching and recognition throughout a moving picture, such as video or the like.

These and other aspects of the present invention will be apparent from, and elucidated with reference to the embodiments described herein.

Embodiments of the present invention will now be described by way of examples only and with reference to the accompanying drawings, in which:

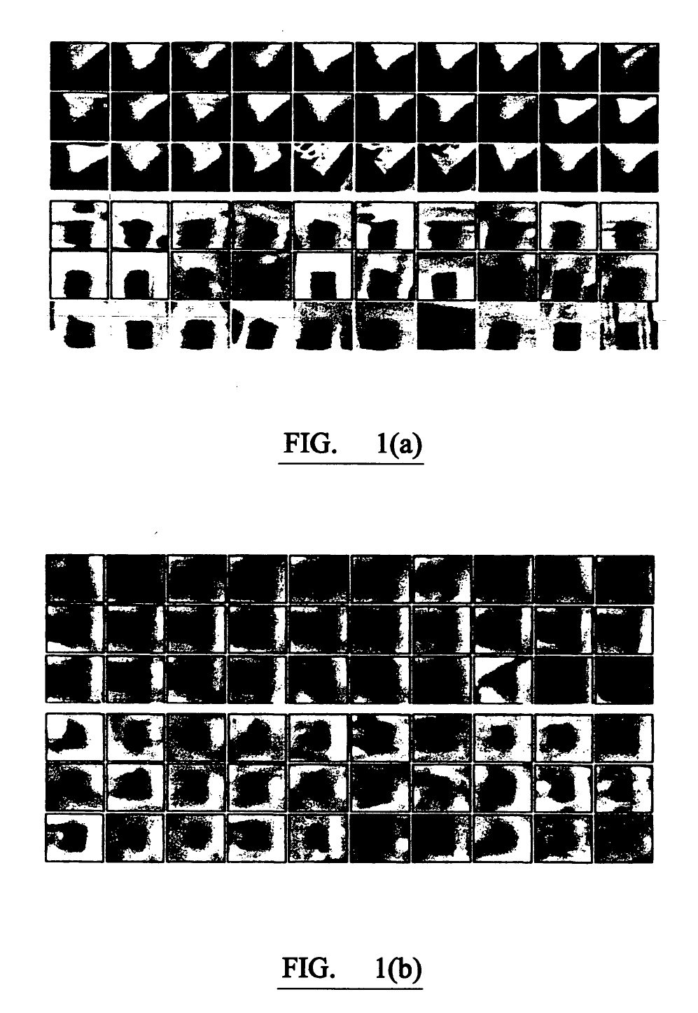

FIG. 1a illustrates samples of clusters corresponding to a single ‘visual word’ with respect to Shape Adapted regions, and FIG. 1b illustrates samples of clusters corresponding to a single ‘visual word’ with respect to Maximally Stable regions of an image;

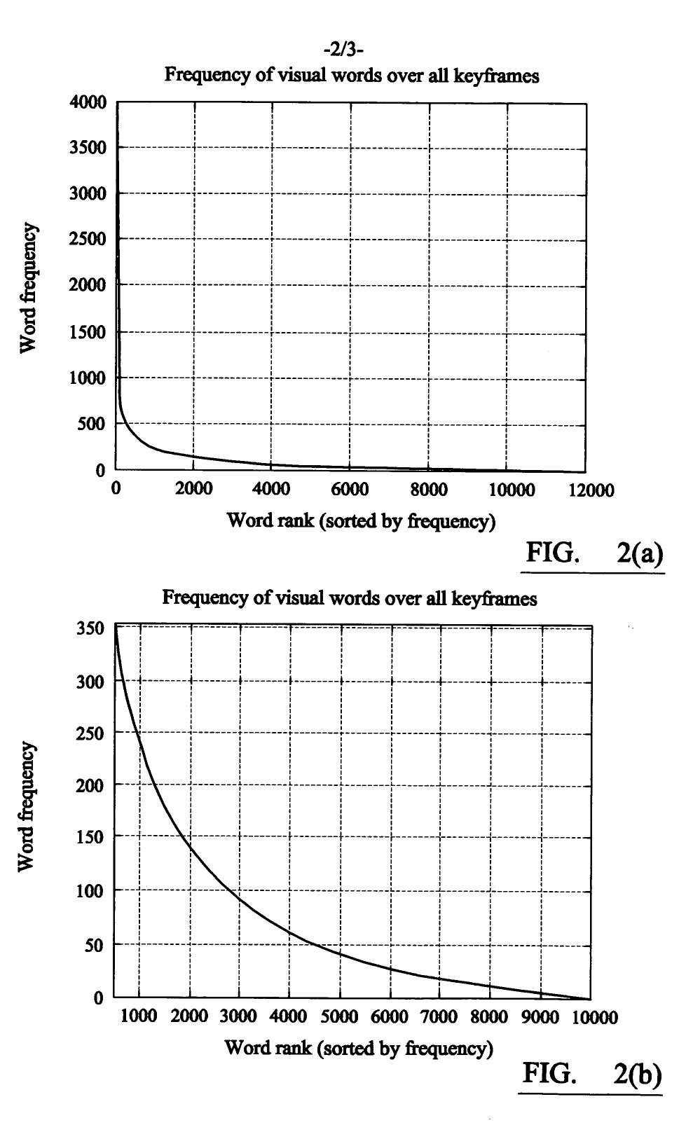

FIGS. 2a and 2b illustrate graphically the frequency of Maximally Stable visual words among all keyframes of a set of image frames before and after, respectively, the application of a stop-list; and

FIG. 3 is a schematic block diagram illustrating the principle of an exemplary embodiment of the second aspect of the invention, relative to a prior art method.

Thus, it is an object of the present invention to retrieve from a plurality of images, key images containing a particular object with ease, speed and accuracy.

This invention propses to recast the standard approach to recognition as text retrieval. In essence this requires a visual analogy of a word, and here it is provided by vector quantizing the image region descriptors. The benefit of this approach is that matches are effectively pre-computed so that run-time frames and shots containing any particular object can be retrieved with little or no delay. This means that any object occurring in a video (and conjunctions of objects) can be retrieved, even though there was no explicit interest in those objects when descriptors were built for the video.

In more detail, two types of viewpoint covariant regions are computed for each frame. The first is constructed by elliptical shape adaptation about an interest point. The method involves iteratively determining the ellipse centre, scale and shape. The scale is determined by the local extremum (across scale) of a Laplacian, and the shape by maximising intensity gradient isotropy over the elliptical region. This region type is referred to as Shape Adapted (SA) and an implementation is described in detail in K. Mikolajczyk and C. Schmid An Affine Invariant Interest Point Detector Proc. ECCV Springer-Verlag, 2002 and in F. Schaffalitzky and A. Zisserman Multi-view matching for unordered image sets, or “How do I organise my holiday snaps? ” Proc. ECCV, volume 1, pages 414-431, Springer-Verlag, 2002.

The second type of region is constructed by selecting areas from an intensity watershed image segmentation. The regions are those for which the area is approximately stationary as the intensity threshold is varied. This region type is referred to as Maximally Stable (MS) and an implementation is described in detail in J. Matas, O. Chum, M. Urban, and T. Pajdla Robust Wide Baseline Stereo from Maximally Stable Extremal Regions Proc. BMVC, pages 384-393, 2002.

Two types of regions are employed because they detect different image areas and thus provide complementary representations of a frame. The SA regions tend to be centred on corner-like features, and the MS regions correspond to blobs of high contrast with respect to their surroundings. Both types of regions are represented by ellipses.

An affine invariant region is represented by a 128-dimensional vector in the form of a descriptor, which is designed to be invariant to a shift of a few pixels in the region position, and this localisation error is one that often occurs. An implementation of the descriptor is described in D. Lowe Object recognition from scale-invariant features Proc. ICCV, pages 1150-1157, 1999. Combining this descriptor with affine covariant regions gives region description vectors which are invariant to affine transformations of the image.

Thus, in order to reduce noise and reject unstable regions, information is aggregated over a sequence of frames. The regions detected in each frame of a video are tracked using, for example, a relatively simple constant velocity dynamical model and correlation, which is known to a person skilled in the art. Any region which does not survive for more than three frames is rejected. Each region of the track can be regarded as an independent measurement of a common scene region (the pre-image of the detected region), and the estimate of the descriptor for this scene region is computed by averaging the descriptors throughout the track. This gives a measurable improvement in the signal to noise of the descriptors.

The next stage is to build a so-called “visual vocabulary”, in which the objective is to vector quantize the descriptors into clusters which are analogous to “words” used for automatic text retrieval. A feature-length film typically has 100K-150K frames, so in order to reduce the complexity of an object retrieval search, a selection of keyframes may be used. This selection could be, for example, one keyframe per second of the film. Descriptors are computed for stable regions in each keyframe and mean values are computed using two frames either side of the keyframe. The vector quantization of the descriptor vectors may be carried out by means of several different methods known to a person skilled in the art, such as K-means clustering, K-medoids, histogram binning, etc. Then, when a new frame of a film is observed, each descriptor of the frame is assigned to the nearest cluster, and this immediately generates matches for all frames throughout the film.

In more detail, regions are tracked through contiguous frames, and a mean vector descriptor computed for each of the regions. In order to reject unstable regions, a predetermined percentage of tracks with the largest diagonal covariant matrix are rejected. To cluster all of the descriptors in a film would be a very large task, so a subset of shots or keyframes is selected. The distance function for clustering may be selected from a number of functions known to a person skilled in the art.

FIG. 1 of the drawings illustrates examples of regions belonging to particular clusters, i.e. which will be treated as the same visual word. FIG. 1a illustrates two examples of clusters of Shape Adapted regions and FIG. 1b illustrates two examples of Maximally Stable regions. The clustered regions reflect the properties of the descriptors which, in this case, penalise variations amongst regions less than correlation.

The reason that SA and MS regions are clustered separately is that they cover different and largely independent regions of a scene. Consequently, they may be thought of as different vocabularies for describing the same scene, and thus should have their own word sets, in the same way as one textual vocabulary might describe architectural features and another the state of repair of a building.

In a text retrieval process, each document is represented by a vector of word frequencies, as explained above. However, it is usual to apply a weighting to the components of this vector. A standard weighting for this purpose is known as ‘term frequency-inverse document frequency’, tf-idf and it is computed as follows. Consider the case of a vocabulary with k words, such that each document can be represented by a k-vector V_{d}=(t₁, . . . , tᵢ, . . . , tₖ)^{T}, of weighted word frequencies with components:

$${t}_{i} = \frac{{n}_{id}}{{n}_{d}} log \frac{N}{{n}_{i}}$$

where n_{id} is the number of occurrences of the word i in document d, n_{d} is the total number of words in the document d, nᵢ is the number of occurrences of the term i in the whole database and N is the number of documents in the whole database. The weighting is a product of two terms: the word frequency n_{id}/n_{d} and the inverse document frequency log N/nᵢ. The intuition is that word frequency weights words occurring often in a particular document, and thus describe it well, whilst the inverse document frequency down-weights words that appear often in the database. At the retrieval stage, documents or ‘hits’ are ranked by their normalised scalar product (cosine of angle) between a query vector V_{q} and all document vectors V_{d} in the database.

In the case of the present invention, a visual query vector analogous to the query vector referred to above is given by the visual words or clusters contained in a user-specified sub- part of a frame, and the other frames can be ranked according to the similarity of their weighted vectors to this query vector. An analogous tf-idf weighting can be used for this purpose, in the sense that for a visual ‘vocabulary’ of k ‘words’ or clusters, each image can be represented by a k-vector V_{d} of weighted cluster or ‘word’ frequencies (t₁, . . . , tᵢ, . . . , tₖ)^{T}, with components as defined above with respect to the text retrieval process, in which case, n_{id} is the total number of occurrences of cluster i in an image frame d, n_{d} is the total number of clusters in the image frame d, nᵢ is the number of occurrences of cluster i in the whole database, and N is the number of image frames in the whole database. As before, the weighting is a product of two terms: the word frequency n_{id}/n_{d} and the inverse document frequency log N/nᵢ, and once again, at the retrieval stage, image frames or ‘hits’ are ranked by their normalised scalar product (cosine of angle) between the query vector V_{q} and all the document or frame vectors V_{d} in the database. It will be appreciated by a person skilled in the art, however, that other weighting methods, such as binary weights (i.e. the vector components are one if the image contains the descriptor, and zero otherwise), or term frequency weights (the components are the frequency of the word or cluster occurrence), are possible.

Object retrieval, ie. the searching for the occurrences of a user-specified object throughout an entire film, for example, will now be described.

The object of interest is specified by the user as a sub-part of any frame of the film. As explained above, a feature length film typically has 100K-150K frames, so in order to reduce the complexity of the search, a selection of keyframes is used (which selection may be manual, random, etc). Descriptors are computed for stable regions in each keyframe and mean values are computed using two frames either side of the keyframe. The descriptors are vector quantized using the precomputed cluster centers.

Returning to the process of object retrieval, using a stop list analogy, the most frequent visual ‘words’ that occur in almost all images are suppressed. Thus, for example, referring to FIG. 2a of the drawings, there is illustrated graphically the frequency of visual words over all of the keyframes of a particular film. A certain top and bottom percentage are stopped and the resultant graphical representation of remaining visual words is illustrated in FIG. 2b of the drawings. It will be appreciated by a person skilled in the art that the stop list boundaries should be determined empirically to reduce the number of mismatches and the size of the inverted file, while retaining a sufficient visual vocabulary for object matching purposes. Note that in a classical file structure, all words are stored in the document in which they appear, whereas an inverted file structure has an entry (or hit list) for each word where all occurrences of the word in all documents are stored. In the case of this exemplary embodiment of the invention, the inverted file has an entry for each visual word, which stores all the matches (i.e. occurrences of the same word) in all frames. More information, such as for example, the spatial image neighbours could be precomputed and stored in the inverted file in addition to each occurrence of a visual word in a frame.

Thus, once the stop-list is applied, a significant proportion of mismatches are removed. The removal of further mismatches can be achieved by, for example, re-ranking the frames retrieved using the weighted frequency vector alone (as described above), based on a measure of spatial consistency. Spatial consistency can be measured quite loosely, simply by requiring that neighboring matches in the query region lie in a surrounding area in the retrieved frame. However, spatial consistency can also be measured very strictly by requiring that neighbouring matches have the same spatial layout in the query region and the retrieved frame. In the case of this exemplary embodiment of the invention, the matched regions provide the affine transformation between the query and retrieved image so a point-to-point map is available for this strict measure.

It is considered that the best performance can be obtained in the middle of this possible range of measures. In one specific example, a search area may be defined by a predetermined number, say 15, nearest neighbours of each match, and each region which also matches within this area casts a vote for that frame. Matches with no support are rejected. The total number of votes then determines the rank of the frame. Other measures which take account of the affine mapping between images may be required in some situations, but this involves a greater computational expense. Thus, the present invention not only makes use of the cluster or “word” frequency, but also their spatial arrangement.

An object of the second aspect of the present invention is to automatically extract and group independently moving 3D rigid or semi-rigid (that is slowly deforming) objects from video shots. An object, such as a vehicle, may be seen from one aspect in a particular shot (e.g. the side of the vehicle) and from a different aspect (e.g.-the front) in another shot, an aim is to learn multi-aspect object models which cover several visual aspects from shots where these are visible, and thereby enable object level matching.

In a video or film shot the object of interest is usually tracked by the camera - think of a car being driven down a road, and the camera panning to follow it, or tracking with it The fact that the camera motion follows the object motion has several beneficial effects for us: the background changes systematically; the background may often be motion blurred (and so features are not detected there); and, the regions of the object are present in the frames of the shot for longer than other regions. Consequently, object level grouping can be achieved by determining the regions that are most common throughout the shot.

In more detail, object level groupings may be defined as determining the set of appearance patches which (a) last for a significant number of frames, and (b) move rigidly or semi- rigidly together throughout the shot. In particular (a) requires that every appearance of a patch is identified and linked, which in turn requires extended tracks for a patch—even associating patches across partial and complete occlusions. Such thoroughness has two benefits: first, the number of frames in which a patch appears really does correspond to the time that it is visible in the shot, and so is a measure of its importance. Second, developing very long tracks significantly reduces the degeneracy problems which plague structure and motion estimation.

Both motion and appearance consistency throughout the shot is preferably used in order to group objects. These are complementary cues and are used in concord. Affine invariant regions are employed as in the first aspect described in detail above, in order to determine appearance patches. These regions deform with viewpoint, and are tracked directly in order to obtain associations over frames. The process of this invention differs from that of layer extraction, or dominant motion detection where generally 2D planes are extracted. In the present case the object may be 3D, and attention is paid to this, and also it may not always be the foreground layer as it can be partially or totally occluded for part of the sequence.

To achieve object level grouping: first, the affine invariant tracked regions are used to repair short gaps in tracks and also associate tracks when the object is partially or totally occluded for a period as described in detail below. The result is that regions are matched throughout the shot whenever they appear. Second, a method of robust affine factorization is employed which is able to handle degenerate motions in addition to the usual problems of missing and mismatched points as is also described in detail below. Such automatically recovered object groupings are sufficient to support, for example, object level matching throughout a feature film.

As explained above, in order to obtain tracks throughout a shot, regions are first detected independently in each frame. The tracking then proceeds sequentially, looking at only two consecutive frames at a time. The objective is to obtain correct matches between the frames which can then be extended to multi-frame tracks. It is here that this exemplary embodiment of the present invention benefits significantly from the affine invariant regions: first, incorrect matches can be removed by requiring consistency with multiple view geometric relations; and second, the regions can be matched on their appearance, the latter being far more discriminating and invariant than the usual cross-correlation over a square window used in interest point trackers.

Thus, in accordance with the second aspect of the invention, a process may be applied for automatically associating image regions or ‘patches’ from frames of a shot into object-level groups, which grouping method employs both the appearance and motion of the patches. As a result, different ‘visual aspects’ of an object, e.g. back, front and side views, can be associated or linked with that object.

A relatively simple region tracker can be used for this purpose, but such a region tracker can fail for a number of reasons, most of which are common to all such feature trackers: (i) no region (feature) is detected in a frame—the region falls below some threshold of detection (e.g. due to motion blur); (ii) a region is detected but not matched due to a slightly different shape; and (iii) partial or total occlusion. A preferred feature of the second aspect of the present invention is to overcome reasons (i) and (ii) by a process for short range track repair using motion and appearance, and to overcome reason (iii) by a process for wide baseline matching on motion grouped objects within one shot, all of which will now be described in more detail. Both of these techniques are known to persons skilled in the art, and will not be described in any further detail herein.

Having computed object level groupings for shots throughout the film, it is now possible to retrieve object matches given only part of the object as a query region. Grouped objects are represented by the union of the regions associated with all of the object's tracks. This provides an implicit representation of the 3D structure, and is sufficient for matching when different parts of the object are seen in different frames. In more detail, an object is represented by the set of regions associated with it in each key-frame. The set of key- frames naturally spans the object's visual aspects contained within the shot.

In this embodiment, the user outlines a query region of a key-frame in order to obtain other key-frames or shots containing the scene or object delineated by the region. The objective is to retrieve all key-frames/shots within the film containing the object, even though it may be imaged from a different visual aspect.

The object-level matching is carried out by determining the set of affine invariant regions enclosed by the query region The object with the majority of tracks within the region is selected, and this determines the associated set of key-frames and affine invariant regions.

Most importantly for many applications in respect of the second aspect of the present invention, different viewpoints of the object can be associated provided they are sampled by the motion within a shot.

It will be appreciated from the above by a person skilled in the art how this approach compares to the more conventional method of tracking interest points alone. There are two clear advantages in the region case: first, the appearance is a strong disambiguation constraint, and consequently far fewer outliers are generated at every stage; second, far more of the image can be tracked using (two types of) regions than just the area surrounding an interest point. The disadvantage is the computational cost, but this is not such an issue in the retrieval situation where most processing can be done off-line.

As a result, useful object level groupings can be computed automatically for shots that contain a few objects moving independently and mainly rigidly or semi-rigidly, and gives rise to the ability to pre-compute object-level matches throughout a film—so that content- based retrieval for images can access objects directly, rather than image regions; and queries can be posed at the object, rather than image, level.

In general, the present invention provides an object matching mechanism which provides substantially immediate run-time object retrieval throughout a database of image frames, such as those making up a film, despite significant viewpoint changes in many frames. The object is specified as the sub-part of an image, which is particularly suitable for quasi- planar rigid or semi-rigid objects. The first aspect of the present invention enables matches to be pre-computed so that, at nm-time, it is unnecessary to search for matches and, as a secondary advantage, it enables the retrieved images or ‘hits’ to be ranked in order of relevance. The second aspect of the present invention enables separate parts of an object that are never visible simultaneously in a single image frame to be grouped together. This can be achieved, in any exemplary embodiment, by using affine invariant regions to repair short gaps in individual tracks across occlusions and, optionally, employs a robust affine factorization method to associate tracks into object-level groups.

Embodiments of the present invention have been described above by way of example only, and it will be apparent to a person skilled in the art that modifications and variations can be made to the described embodiments without departing from the scope of the invention as defined by the appended claims. Further, in the claims, any reference signs placed between parentheses shall not be construed as limiting the claim. The term “comprising” does not exclude the presence of elements or steps other than those listed in a claim. The terms “a” or “an” does not exclude a plurality. The invention can be implemented by means of hardware comprising several distinct elements, and by means of a suitably programmed computer. In a device claim enumerating several means, several of these means can be embodied by one and the same item of hardware. The mere fact that measures are recited in mutually different independent claims does not indicate that a combination of these measures cannot be used to advantage.

1. A method of identifying a user-specified object contained in one or more images of a plurality of images, the method comprising defining regions of objects in said images, computing a vector in respect of each of said regions based on the appearance of the respective region, each said vector comprising a descriptor, vector quantizing said descriptors into clusters, storing said clusters as an index with the images in which they occur, defining regions of said user-specified object, computing a vector in respect of each of said regions based on the appearance of said regions, each said vector comprising a descriptor, and vector quantizing said descriptors into said clusters, searching said index and identifying which of said plurality of images contains said clusters so as to return the images containing said user-defined object.

2. A method according to claim 1, further comprising comparing the clusters relating to the objects contained in the images identified as containing an occurrence of said user-specified object with the one or more clusters relating to said user-specified object, and ranking said images identified as containing an occurrence of said user- specified object according to the similarity of the one or more clusters associated therewith to the cluster associated with said user-specified object.

3. A method according to claim 1, wherein at least two types of viewpoint covariant regions are defined in respect of each of said images.

4. A method according to claim 3, wherein a descriptor is computed in respect of each type of viewpoint covariant region.

5. A method according to claim 4, wherein one or more separate clusters are formed in respect of each type of viewpoint covariant region.

6. A method according to claim 3, wherein said at least two types of viewpoint covariant regions include Shape Adapted and Maximally Stable regions respectively.

7. A method according to claim 1, wherein said user-specified object is specified as a sub-part of an image.

8. A method according to claim 7, wherein identification of said user-specified object is performed by first vector quantizing the descriptor vectors in a sub-part of an image to precomputed cluster centers.

9. A method according to claim 1, wherein the regions defined in each image are tracked through contiguous images and unstable regions are rejected.

10. A method according to claim 9, wherein an estimate of a descriptor for a track is computed from the descriptors throughout the track.

11. A method according to claim 1, wherein each image or portion thereof is represented by one or more cluster frequencies.

12. A method according to claim 11, wherein said cluster frequency is weighted.

13. A method according to claim 1, wherein a predetermined proportion of most frequently occurring clusters in said plurality of images are omitted from or suppressed in such index.

14. A method according to claim 1, wherein said index comprises an inverted file structure having an entry for each cluster which stores all occurrences of the same cluster in all of said plurality of images and possibly more precomputed information about each cluster occurrence such as for example its spatial neighbours in an image.

15. A method according to claim 1, including the step of ranking said images using local image spatial coherence or global relationships of said descriptor vectors.

16. A method of identifying a user-specified object contained in one or more image frames of a moving picture, the method comprising associating a plurality of different ‘visual aspects’ with each of a plurality of respective objects in said moving picture, retrieving the ‘visual aspects’ associated with said user- specified object, and matching said ‘visual aspects’ associated with said user-specified object with objects in said frames of said moving picture so as to identify instances of said user-specified object in said frames.

17. A method according to claim 16, wherein the ‘visual aspects’ associated with an object are obtained using one or more sequences or shots of a moving picture in which said object occurs.

18. A method according to claim 16, comprising tracking said object through a plurality of image frames in a sequence.

19. A method according to claim 18, comprising defining affine invariant regions of objects in said image frames and tracking one or more regions through a plurality of image frames in a sequence.

20. A method according to claim 19, comprising, in the event that a track terminates in an image fame of a sequence, propagating the track to either following or preceeding image frames in the sequence, so as to create a substantially continuous track throughout the image frames in the sequence.

21. A method according to claim 19 where tracked regions are grouped into objects according to their common motion using constraints arising from rigid or semi- rigid object motion.
